(19) United States
(12) Patent Application Publication
(10) Pub. No.: US 2015/0294347 A1
(43) Pub. Date: Oct. 15, 2015

(54) BILLBOARD MARKETING SYSTEM AND METHOD

(71) Applicant: NICOLAS CLIFTON PLACIDE, Miami, FL (US)

(72) Inventor: NICOLAS CLIFTON PLACIDE, Miami, FL (US)

(21) Appl. No.: 14/252,587

(22) Filed: Apr. 14, 2014

(51) Int. Cl. G06Q 30/02; H04W 4/02; H04W 64/00

(52) U.S. Cl. CPC G06Q 30/0242; H04W 64/00; H04W 4/02

(57) ABSTRACT

A billboard marketing system that enhances the marketing capacity of a billboard by enabling positioning data and interactive communications to and from the billboard. The system enables a consumer and an advertiser to rate, track, and interact with the billboard. In this manner, the consumer views the billboard contents more thoroughly, and the advertiser optimizes the advertising capacity of the billboard and gains valuable marketing information. A consumer can identify the location of the billboard and view the billboard content in a more thorough manner. The consumer can then interact accordingly. The interaction can be a discount request, a review, an inquiry, or a purchase of a product or service displayed on the billboard. An advertiser can understand the amount and type of consumers viewing the billboard. The system creates a latitudinal and longitudinal data, along with an interaction data, which can be stored and retrieved for marketing.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to an outdoor advertising structure, such as a billboard that enables a consumer and an advertiser to interact and identify locations of the billboard and the consumer for enhancing marketing and consuming capacities.

Typically, a billboard is a large outdoor advertising structure, typically found high-traffic areas such as alongside busy roads. Billboards present large advertisements to passing pedestrians and drivers. Typically showing large, ostensibly witty slogans, and distinctive visuals, billboards are highly visible in the top designated market areas.

It is known that billboards are designed to attract the attention of those in their vicinity. However, regardless of how interesting a billboard located on the side of a road or highway might be, the high rate of velocity and the need to give attention to the road in front of the driver limits the amount of time each driver can view the billboard. This reduces the advertising capacity of the billboard.

Furthermore, with many billboards being digital, drivers have even less time to read something they might have been interested in and may never see that information again. The billboard content follows a rolling scheme, with each product or service displaying for a matter of seconds before being replaced.

Additionally, billboard advertising can be expensive. The advertisers desire to know if and when their advertised product or service is viewed and digested by the drivers. Nonetheless, it is difficult for advertisers to assess the effectiveness of the billboard advertising.

Typically, marketing is the process of communicating the value of a product or service to customers, for the purpose of selling that product or service. Marketing can be looked at as an organizational function and a set of processes for creating, delivering and communicating value to customers, and managing customer relationships in ways that also benefit the organization. The billboard can be a substantial part of a marketing effort.

The marketing of the billboard content can be enhanced if the billboard can somehow interact with the consumer and the advertiser, and then store the subsequently collected data. Additionally, if the location of the billboard, and the consumer are known, especially while the interaction is taking place, the advertiser may have vastly greater knowledge of the behavior of the consumer.

Furthermore, it is known that the consumer can better benefit from the billboard if the billboard content is made more available, such as saving the billboard content for a subsequent moment when the driver has stopped and has time to fully engage the billboard content. Another possibility to make the billboard content more interactive and available is to enable the consumer to purchase a product or service wirelessly from the billboard.

For the foregoing reasons, there is a billboard marketing system that enhances the marketing capacity of a billboard by enabling positioning data and interactive communications to and from the billboard.

Billboards and interactive media have been utilized in the past; yet none with the present billboard interactive functions and positioning systems of the present invention. See U.S. Pat. No. 20040128891; 20100306064; and 7,098,869.

For the foregoing reasons, there is an interactive billboard that displays a position of the billboard and a consumer during an interaction and stores the subsequent interactive data and positional data in a data storage unit for marketing purposes.

### SUMMARY

The present invention is directed to a billboard marketing system that enhances the marketing capacity of a billboard by enabling interactive communications and positional data to exchange between the billboard and an advertiser and consumer. The system enables a consumer and an advertiser to rate and track the billboard, while also interacting. In this manner, the consumer views the billboard contents more thoroughly, and the advertiser optimizes the advertising capacity of the billboard and gains valuable marketing information. In some embodiments, the system may help a consumer identify the location of the billboard and view the billboard content in a more thorough manner. The consumer may then interact with the billboard accordingly. The system is also useful for helping an advertiser understand the amount and type of consumers viewing the billboard. The system creates a latitudinal and longitudinal data, along with an interaction data, which can be stored for future marketing and billboard analysis.

In some embodiments, the billboard marketing system enables a consumer viewing a billboard to track and interact with the billboard. Additionally, the system enables an advertiser placing billboard content on the billboard to track the performance of the billboard, as well as analyze data collected from the billboard and consumer interactions. In some embodiments, the billboard marketing system enables a consumer to identify the exact location of the billboard through a positioning system, such as a global positioning system (GPS). The positioning system can be used to identify the location of the billboard relative to the consumer and a plurality of other billboards. The location of the consumer at the time of interaction with the billboard can also be determined with the positioning system. Further, the positioning system enables the consumer to view and interact with specific billboard content and advertisements.

The system further enables the consumer to review or rate the billboard against other billboards having similar content. This rating system can help the consumers and the advertiser better understand the type of products and services offered by the billboard. For example, the feedback for the consumer can inform the advertiser how effective the billboard is in converting the advertisement into a sale, the socio-economic level of the consumer, or needs of the consumer. A product or service advertised on the billboard may also be reviewed.

In yet another embodiment, the consumer may interact with the billboard to request coupons, add the advertiser website to favorites, and locate a URL website page for the advertiser. The advertiser can also interact with the billboard to analyze the amount and type of consumers in proximity to the billboard, and assess the performance of the billboard. The billboard related information comprises generally, a latitude and longitude data, and an interactive data. The data is processed in a processing unit, and then stored in a data storage unit for subsequent queries and marketing efforts.

One objective of the present invention is to provide a system to rate, track, and interact with any type of billboard, whether digital, animated, or static; and regardless of the location of the consumer at the time of interaction.

Another objective is to enable the advertiser to track the performance of the billboard.

Another objective is to provide a system that makes it possible to click on the content of any billboard previously added to the data storage unit and receive historical marketing information.

Another objective is to allow advertisers to easily assess the performance of specific locations, and to target high traffic areas.

Another objective is to create a ranking system boards nationally and internationally.

Another objective is to enable the consumer to save specific advertisements for future viewing.

Another objective is to provide the consumer with instant coupons, distance, and directions to a place of business for an advertiser.

Another objective is to allow advertisers to directly sell products seen on the billboard, as well as associated products.

### DRAWINGS

These and other features, aspects, and advantages of the present invention will become better understood with regard to the following description, appended claims, and drawings where:

FIG. 1 is a block diagram of a first embodiment of an exemplary billboard marketing system;

FIG. 2 is a block diagram of a second embodiment of an exemplary billboard marketing system;

FIG. 3 is a flowchart diagram of an exemplary method for billboard marketing;

FIGS. 4A and 4B are flowchart diagrams of an exemplary method for registering a new advertiser;

FIG. 5 is a flowchart diagram of an exemplary profile management module;

FIG. 6 is a flowchart diagram of an exemplary profile creation module;

FIG. 7 is a flowchart diagram of all exemplary board management module;

FIG. 8 is a flowchart diagram of an exemplary board creation nodule;

FIG. 9 is a flowchart diagram of an exemplary board details module;

FIG. 10 is a flowchart diagram of an exemplary board location module;

FIG. 11 is a flowchart diagram of an exemplary rotation time module;

FIG. 12 is a flowchart diagram of an exemplary advertisement management module; and

FIG. 13 is a block diagram depicting an exemplary client/server system which may be used by an exemplary web-enabled/networked embodiment of the present invention.

### DESCRIPTION

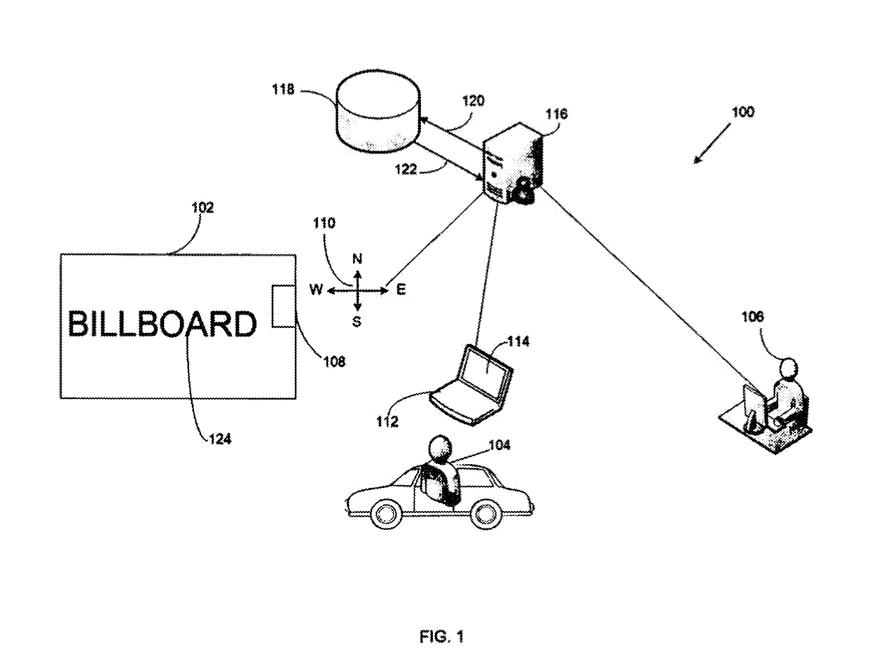

FIGS. 1-4 illustrate a billboard marketing system 100, and a billboard marketing method 200. The present invention is directed to a billboard marketing system 100 that enhances the marketing capacity of a billboard 102. The system 100 enables a consumer 104 and an advertiser 106 to rate and track the billboard 102, while also interacting with the billboard 102. In some embodiments, the system 100 helps a consumer 104 identify the location of the billboard 102 and the billboard content 124. The consumer 104 may then interact with the billboard 102 accordingly. Additional interactions that the system 100 enables may include the consumer 104 receiving coupons from products or services advertised on the billboard 102, rating the billboards, rating the products or services advertised on the billboard 102, making purchases of products or services advertised on the billboard 102, and sharing the content of the billboard with associates, such as social media sites.

Additionally, the system 100 is useful for helping an advertiser 106 understand the amount and type of consumers 104 viewing the billboard 102. The advertiser 106 can track the purchasing habits, routes, and reviews of the consumer 104 for marketing purposes and also to enhance the performance of the billboard 102. The billboard related data and the consumer interaction data can be processed and stored for future marketing and analyses of the billboard 102.

As referenced in FIG. 1, the billboard marketing system 100 enables a consumer 104 within proximity to a billboard 102 to view, track, and interact with the billboard 102. The billboard 102 enables an advertiser 106 to provide an advertisement on the billboard 102, and a consumer 104 to view the advertisement. The billboard 102 may include, without limitation, a static billboard, a digital billboard, a moving billboard, a poster, and a generally publically viewable advertisement. The consumer 104 may have a better opportunity to view and digest the billboard content 124 within the parameters of the system 100.

Additionally, the system 100 enables an advertiser 106 placing advertisements on the billboard 102 to track the location and performance of the billboard 102 and the consumer 104 at the time of an interaction. The system 100 also enables the advertiser 106 to analyze various datum, including data collected from the billboard 102, latitude and longitude data 110, and interaction data 122 between the consumer 104 and the billboard 102. The advertiser 106 can analyze the datum for marketing purposes. In this manner, the advertiser 106 optimizes the resources spent advertising on the billboard 102. In one embodiment, both the consumer 104 and the advertiser 106 may view the datum by logging in to the system 100.

The consumer 104 can interact with the billboard 102 to request coupons, make purchases, add to favorites, and locate a URL website page. The interaction between the consumer 104 and the billboard 102 creates an interaction data 122 that is stored and studied for marketing purposes. The interaction occurs between the computer 112 and the processing unit 116. In general, the computer 112, through the consumer 104, requests an interaction or location of the billboard 102 from the processing unit 116. The processing unit 116 performs a query 120 to the data storage unit 118 to access the datum. The requested datum, if stored in the data storage unit 118, is transmitted back to the processing unit 116, and finally to the computer 112, where the consumer 104 views the datum on a screen 114. The screen 114 may display the datum in various formats, including, without limitation, images, maps, spreadsheets, audio, video, web links, distance from the business advertised on the billboard 102, available coupons, and the like.

In some embodiments, the system 100 enables the consumer 104 to save the billboard content 124 in the computer 112 while traveling past the billboard 102. For example, the consumer 104 drives past the billboard 102 at a high velocity, and cannot read the details of the billboard content 124. The consumer 104 can save the billboard content 124 and later retrieve the billboard content 124 for viewing. In another embodiment, the system 100 enables the consumer 104 to review or rate the billboard 102 against a plurality of billboards having similar billboard content 124. The review may include, without limitation, a numbering system, a lettering system, a star system, and a thumbs up-thumbs down system.

The consumer 104 can review and rate the billboard 102 or product and service displayed by the billboard. The ratings can help the consumer 104 and the advertiser 106 better understand the type of products and services offered by the billboard 102, and the optimal marketing of the products and services. For example, the feedback for the consumer 104 can inform the advertiser 106 about the billboard 102 and the consumer 104, including: how effective the billboard 102 is in converting the advertisement into a sale, the socio-economic level of the consumer 104, and the greatest needs requested by the consumer 104. In one embodiment, the review may be applied and viewed nationally and internationally.

In another embodiment, the system 100 enables the consumer 104 to view the location of the billboard 102 through the positioning system 108. For example, the consumer 104 can view the billboard content 124 on a specific billboard 102, and later find the location of the billboard 102 having that same billboard content 124.

In another embodiment, the consumer 104 may set alarms to alert about a specific billboard 102 and the billboard contents 124. The consumer 104 may set the alarm at a predetermined distance from the desired billboard 102. In this manner, the consumer 104 may be reminded to interact with the billboard 102 for receiving coupons, rating billboards 102, rating products or services advertised on the billboard 102, and sharing the billboard content 124 with associates, especially on social media sites. However, to interact with the billboard 102, the system 100 may require that the consumer 104 be logged in to the system 100. Once logged in, the consumer 104 may interact with the provided information and request coupons, directions, make a purchase, and the like.

In some embodiments, the system 100 enables the advertiser 106 to identify the exact location of the billboard 102 and/or the consumer 104 through a positioning system 108, such as a global positioning system (GPS). However in other embodiments, the positioning system 108 may include, without limitation, a Wi-Fi tower system, a radio frequency locating system, a laser system, and a sound positioning system. In either case, the location is determined in real time, and the advertiser 106 can act accordingly based on the location and interaction activity. However in some embodiments, the advertiser 106 may request to know the location of the billboard 102 from a billboard operator, rather than the positioning system 108.

In one example, the processing unit 116 receives a latitude and longitude data 110 and interaction data 122 from the positioning system 108 for processing and appropriate distribution. The latitude and longitude data 110 may then be stored in a data storage unit 118. The data storage unit 118 may include, without limitation, a server, a database, a central processing unit, a cloud, and a network. A query 120 is made by the computer 112 from the advertiser 106 to the data storage unit 118 to retrieve the interaction data 122 and the latitude and longitude data 110 for marketing purposes.

In one embodiment, the positioning system 108 can be used to identify the location of the billboard 102 relative to the consumer 104 and a plurality of other billboards 102. The location of the consumer 104 is also determined by the positioning system 108. In this manner, the positioning system 108 enables the advertiser 106 to better understand the performance of the billboard 102 by tracking the number of consumers 104 that view the billboard 102, along with the interactions between the consumer 104 and the billboard 102. The latitude and longitude data 110 of the billboard 102 are also viewable on the screen 114 of the computer 112 by the consumer 104 and/or the advertiser 106. The movement of the consumer 104 in relation to various billboards 102 is also tracked.

In another embodiment, the system 100 enables the advertiser 106 to identify the exact location of the consumer 104 at the time and place that the consumer 104 submitted an interactive command to the billboard 102. This information enables the advertiser 106 to record interactive information about the consumer 104, such as the number of consumers 104 viewing the billboard 102, the type of requests made by the consumer 104, the amount of time spent in front of the billboard 102 by the consumer 104, and the overall performance of the billboard 102.

Those skilled in the art will recognize that by tracking movement of the consumer 104 through the positioning system 108, the advertiser 106 can record routes as they are being traveled by the consumer 104. Additionally, the consumer 104 can interact with a billboard 102 having a specific billboard content 124. For example, if previously traveled routes are saved in the data storage unit 118, the advertiser 106 and/or consumer 104 can select and load a route that highlights a corresponding section on a map on the screen 114 of the computer 112. The highlights indicate the location of the different billboards 102 on the route, and the past routes traveled by the consumer 104. In this manner, selecting a billboard icon for a particular location on the route results in the screen 114 displaying the content of the billboard 102 at that location. The advertiser 106 can then better understand the behavior of the consumer 104, and the consumer 104 can return to a billboard 102 to view a specific billboard content 124.

In some embodiments, the advertiser 106 can interact with the billboard 102 to analyze the amount of consumers 104 in proximity to the billboard 102, and assess the performance of specific locations for each billboard 102. The billboard 102 related information is stored in a data storage unit 118 for subsequent queries and marketing efforts.

In one example, once the advertiser 106 submits a request through the computer 112, the system 100 queries the positioning system 108 attached to the billboard 102 to obtain the current latitude and longitude data 110 of the consumer 104 and/or the billboard 102. That latitude and longitude data 110 is then sent through the Internet to the processing unit 116, which then queries the data storage unit 118 to determine which billboards 102 were closer to the consumer 104 at the time the interaction was submitted. Those skilled in the art will recognize that knowing which billboards 102 the consumer 104 has viewed, enables the processing unit 116 to lookup the billboard content 124, as well as other relevant data. The processing unit 116 may then format the interactive data 122 and the latitude and longitude data 110 and send the resulting dataset to the computer 112. The relevant datum regarding all interaction with the consumer 104 is stored in the data storage unit 118; thereby providing valuable marketing data to the advertiser 106.

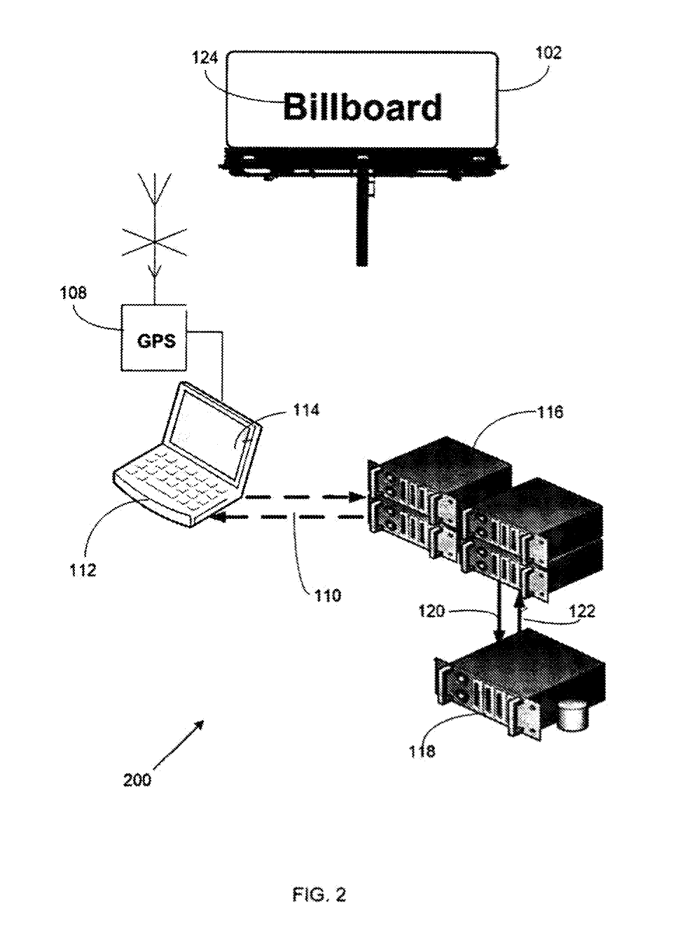

Turning now to FIG. 2, a second embodiment of a billboard marketing system 200 utilizes the positioning system 108 to help the advertiser 106 better understand the location of the billboard 102 in relation to the consumer 104, and the consumer 104 at he time of an interaction. The positioning system 108, such as a GPS, positions a transmitter on the billboard 102 to provide the location and time information about the billboard 102, and the consumer 104 traveling in proximity to the billboard 102. The positioning system 108 acquires latitude and longitude data 110 from positioning satellites orbiting the earth and makes that information available to the computer 112. In one example, the positioning system 108 comprises a GPS that uses multiple frequencies to receive different signals from various global positioning satellites orbiting around the earth. The GPS transforms those signals into the latitude and longitude data 110.

In some embodiments, the datum pertinent to the billboard 102 are displayed on a computer 112 operated by the consumer 104 and/or the advertiser 106. The computer 112 processes different type of data such as latitude and longitude data 110 obtained from the positioning system 108, interactive data 122 obtained from the interactive requests of the consumer 104, user input data from interaction with the user, as well as data received from the processing unit 116, according to instructions stored in memory. The computer 112 provides the consumer 104 and the advertiser 106 with a visual interface used to interact with the processing unit 116. Instructions stored in the memory of the computer 112 determine how it should react to the received datum. Some datum may be processed locally while other sets of data have to be sent to the processing unit 116 for further transformation and/or storage in the data storage unit 118.

In some embodiments, the computer 112 may transmit the latitude and longitude data 110 to a processing unit 116 which, sends the latitude and longitude data 110 to the data storage unit 118 for storage. The processing unit 116 may contain billboard locations, billboard content 124, landing page URL, ad expiration date, as well as other relevant data for all billboards 102 meeting the specifications set by the query 120 to the data storage unit 118.

In one embodiment, the processing unit 116 transforms data received from the computer 112 into a different set of data according to instructions programmed in its memory and based on data stored in the data storage unit 118. The processing unit 116 may include a processing computer, or group of processing computer that operates as a unit. The processing unit 116 may contain instructions that enables it to process data from the computer 112 operated by the consumer 104. The processing unit 116 uses instructions stored its memory as well as data contained within the data storage unit 118 to transform the received data into another set of data.

In some embodiments, the processing unit 116 may use an algorithm to determine which billboards 102 are proximal to the consumer 104, and the location of the consumer 104 relative to the billboard 102 at the time the consumer 104 submits an interactive request or command to a billboard 102. Once that determination is made, the processing unit 116 formats the relevant data according to instructions stored in a data storage unit 118 and sends that data back to the computer 112 which then displays the information on the screen 114. Optionally, the consumer 104 may further interact with the data through the computer 112 to rate the billboard 102, request coupons, add to favorites, eat out, and the like. All interaction with the consumer 104 are recorded by the processing unit 116 into the data storage unit 118, and may be easily retrieved later if further analysis is desired.

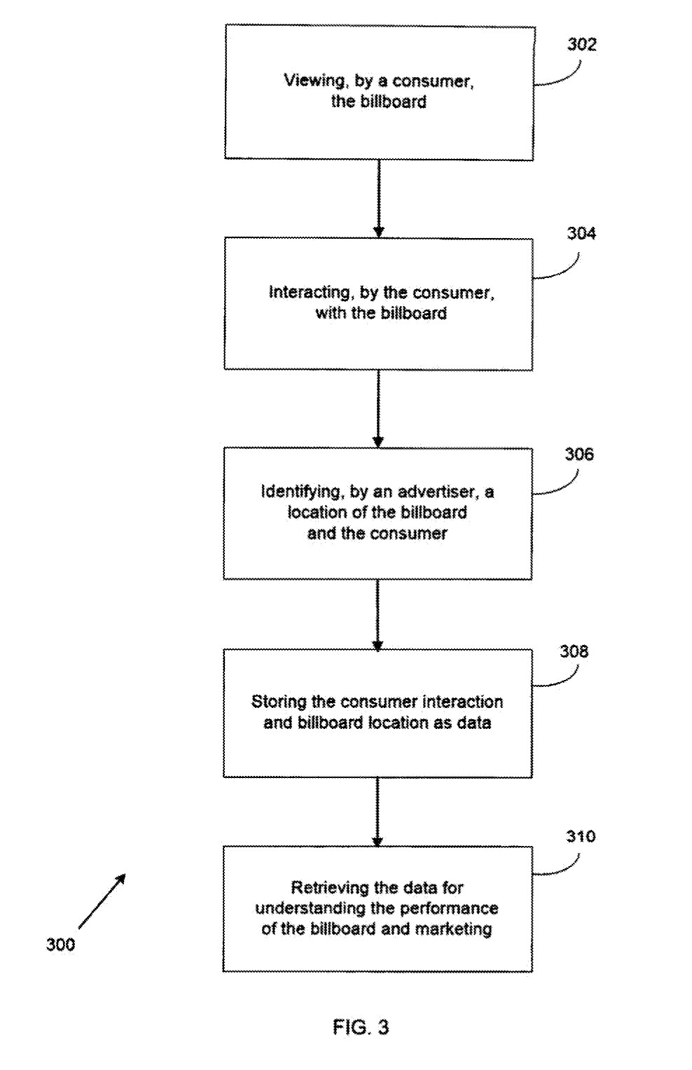

FIG. 3 shows a billboard marketing method 300 for rating, tracking, and interacting with a billboard 102. The method 300 allows a consumer 104 to track the billboard 102 for various functions, such as reviewing, making purchases, obtaining additional information, and determining a location of the billboard 102. The consumer 104 generally performs these functions through a novel interactive system provided by the present invention. In this manner, the consumer 104 becomes more informed about the billboard content 124 and subsequently, can receive benefits, such as ordering coupons or requesting additional information about the product or service advertised on the billboard 102. Additionally, the advertiser 106 may track the performance of the billboard 102 by better understanding the interactions between the consumer 104 and the billboard 102, and the needs of the consumer 104.

In some embodiments, an initial Step 302 of the present invention may include viewing, by a consumer 104, the billboard 102. The consumer 104 may be traveling on a route within visual distance of the billboard 102. The consumer 104 may view and save the billboard content 124 for future use. The interaction between the consumer 104 and the billboard 102 is recorded and transmitted for further processing to the processing unit 116, and then stored in the data storage unit 118.

A Step 304 comprises interacting, by the consumer 104, with the billboard 102. The interaction may include the consumer 104 receiving coupons, rating billboard 102, rating products or services advertised on the billboard 102, purchasing products or services on the billboard, and sharing the billboard content 124 with associates, especially on social media sites. The method 300 may further include a Step 306 of identifying, by an advertiser 106, the location of the billboard 102 and/or the consumer 104. The advertiser 106 can utilize the positioning system 108 to identify the location of the billboard 102 containing the billboard content 124 of the advertiser 106. Furthermore, by tracking movement of the consumer 104 with the positioning system 108, the advertiser 106 can record routes as they are being traveled by the consumer 104, and the consumer 104 can interact with a billboard 102 having a specific billboard content 124.

A Step 308 includes storing the consumer interaction and the billboard location as data in a data storage unit 118. The data comprises a longitude and latitude data 110, and an interaction data 122. The data storage unit 118 may include a server, a cloud, or a network that receives the data from the processing unit 116 and stores the data accordingly. The data may subsequently be used for marketing. A final Step 310 comprises retrieving the datum for understanding the performance of the billboard 102 and for optimizing marketing. The data may include the location of the billboard 102, the consumer 104, an interaction between the consumer 104 and the billboard 102. Additionally, the datum can encompass, a route taken by the consumer 104, the most requested product or service, the number of consumers 104 passing a billboard 102, and the times of day for the interactions can be used to enhance the performance of the billboard 102 and market to the consumer 104 more efficiently. However, other data can be gathered and analyzed for marketing through the use of the positioning system 108 and data processing and storage means provided by the system 100.

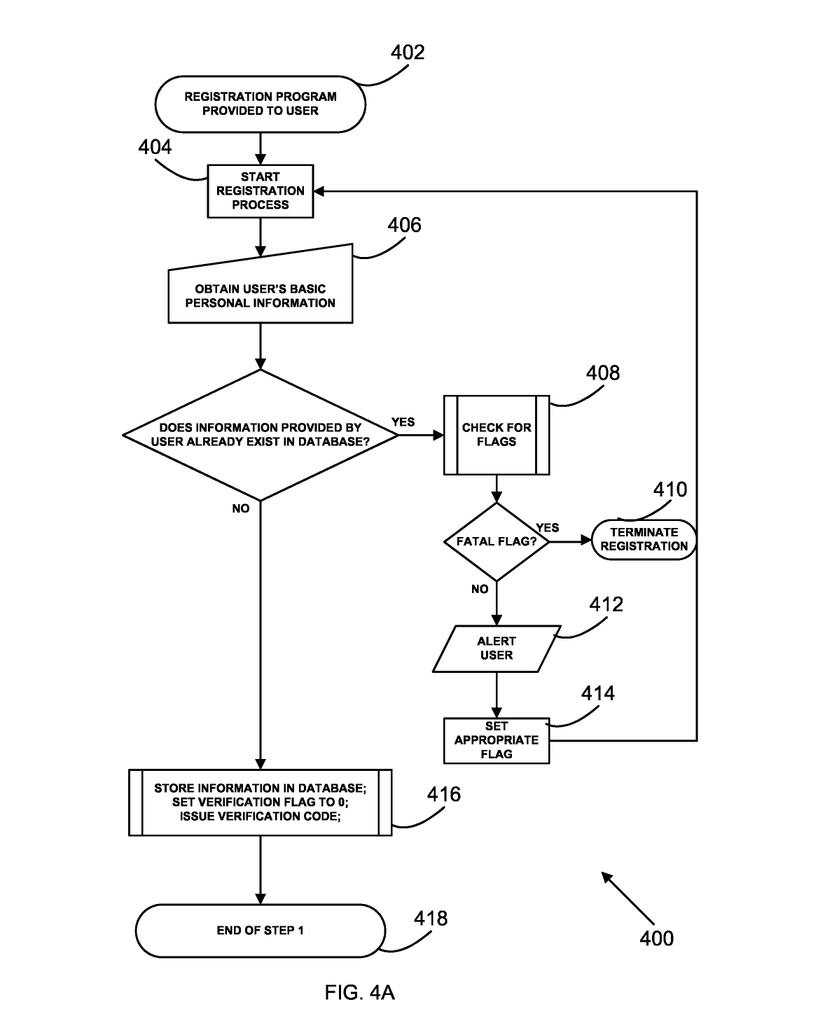

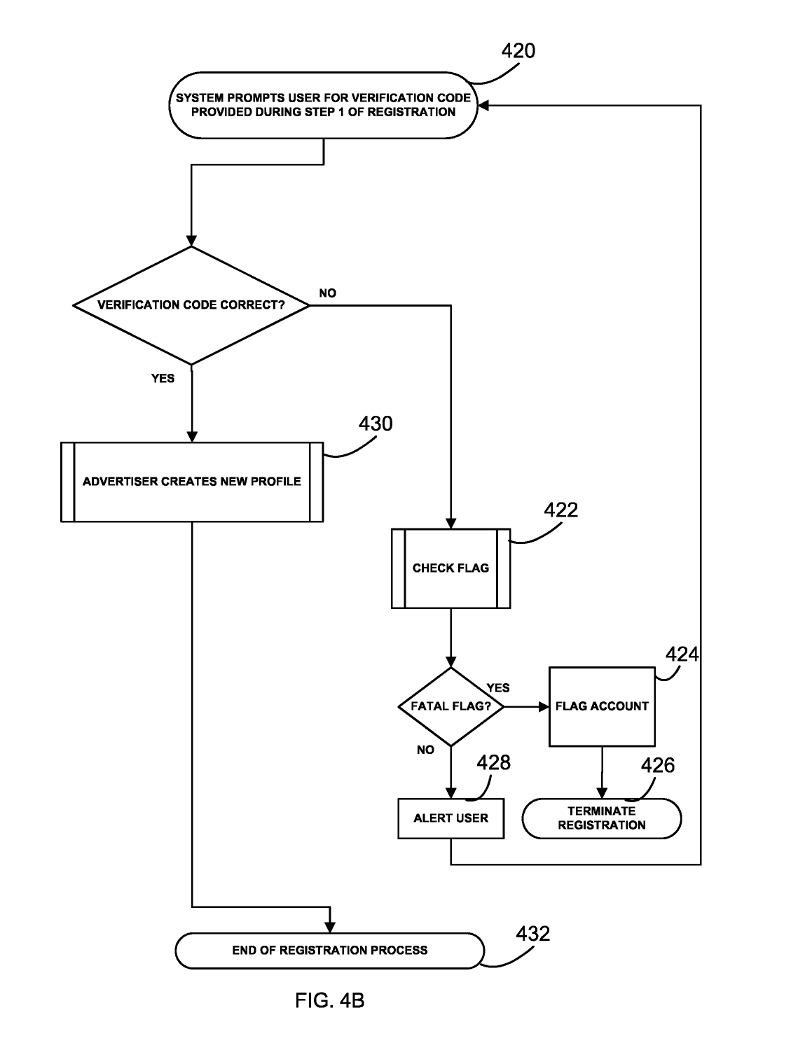

FIGS. 4A and 4B are flowchart diagrams of an exemplary method 400 for registering a new advertiser. In some embodiments, the advertiser 106 may register to participate in the system 100 for displaying advertisements on the billboards 102. The advertiser 106 can also register the type of product or service advertised on the billboard 102. In this manner, the system 10 can identify the optimal billboard 102 for the advertiser 106, and the integrity of the system 10 is better managed. The method 400 for registering a new advertiser may include an initial Step 402 of providing the registration to the advertiser 106. The registration may include forms and questionnaires for the advertiser 106 to fill out. A Step 404 comprises starting the registration process. The registration process initiates through a request upon the advertiser 106 deciding to partake in the system 100.

In some embodiments, a Step 406 includes obtaining the advertiser information. The information may include, without limitation, company name, address, years of doing business, and product or service offered. If the advertiser 106 is already registered with the system 100, a Step 408 includes checking for flags. The flags indicate issues or a problematic advertiser 106. For example, a scam business or a business having a history of bankruptcies. The system 100 can utilize background checks or credit checks to check for flags. If the flag is fatal, a Step 410 comprises terminating the registration. The determination of a fatal flag is determined by numerous factors, and may be subjective or objective. If the flag is not fatal, a Step 412 alerts the advertiser 106. A Step 414 may then set the appropriate flag for the advertiser 106. In some embodiments, if the advertiser 106 is not in the system 100, a Step 416 of storing the information form the advertiser 106 in a database can be performed. The verification flag can be set to a numerical value of zero, indicating a new advertiser. A verification code is then issued to the advertiser 106. A Step 418 terminates the registration process, and the advertiser 106 may thus participate.

In some embodiments, the method 400 for registering a new advertiser may continue to a Step 420, prompting the advertiser 106 for the verification code provided in Step 418. If the verification code is not entered correctly, a Step 422 automatically enables the system to check the flag. If the flag is fatal, a Step 424 flags the account of the advertiser 106, and a Step 426 terminates the registration. However, if the flag is not fatal, a Step 428 alerts the advertiser 106, and the advertiser 106 may then return to Step 420 to be prompted for the verification code again. However, if the verification code is entered correctly, a Step 430 enables the advertiser 106 to create a new profile, if desired. A final Step 432 may then terminate the registration process.

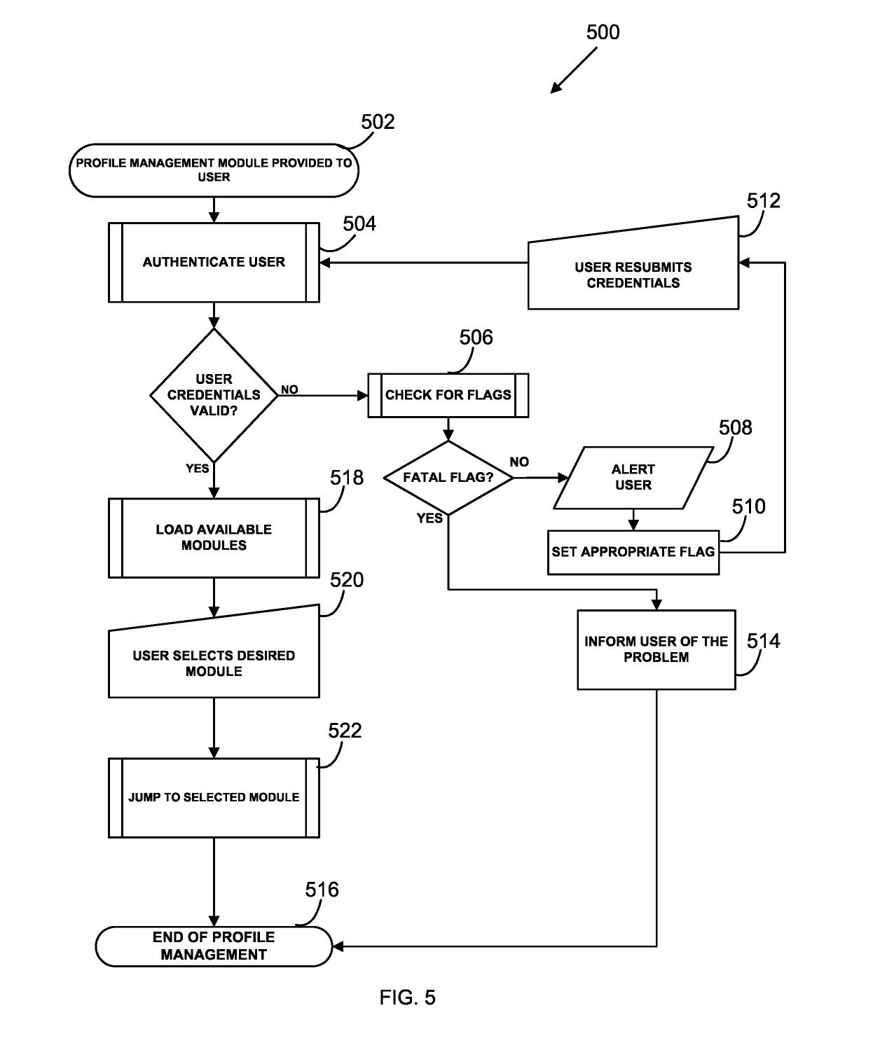

FIG. 5 is a flowchart diagram of an exemplary profile management module 500. The profile management module 500 enables the system 100 to better manage the registration and information from the advertiser 106. The profile management module 500 initiates with a Step 502 of providing the advertiser 106 with a profile module. A Step 504 may then include authenticating the credentials of the advertiser 106. If the credentials are not valid, a Step 506 comprises checking for flags. If the flags are not fatal, a Step 508 may include alerting the advertiser 106. A Step 510 involves setting the appropriate flag after alerting the advertiser 106. The advertiser 106 may then resubmit the credentials in a Step 512. The advertiser 106 may then proceeds back to Step 504 of authenticating the credentials of the advertiser 106. If the flag is fatal, a Step 514 involves informing the advertiser 106 of the problem. A Step 522 can then end the profile management module 500. However, if the credentials of the advertiser 106 are valid, a Step 518 involves loading the appropriate modules. A Step 520 enables the advertiser 106 to select a desired module. A Step 522 comprises jumping to the selected module. The final Step 522 of ending the profile management module 500 terminates the process.

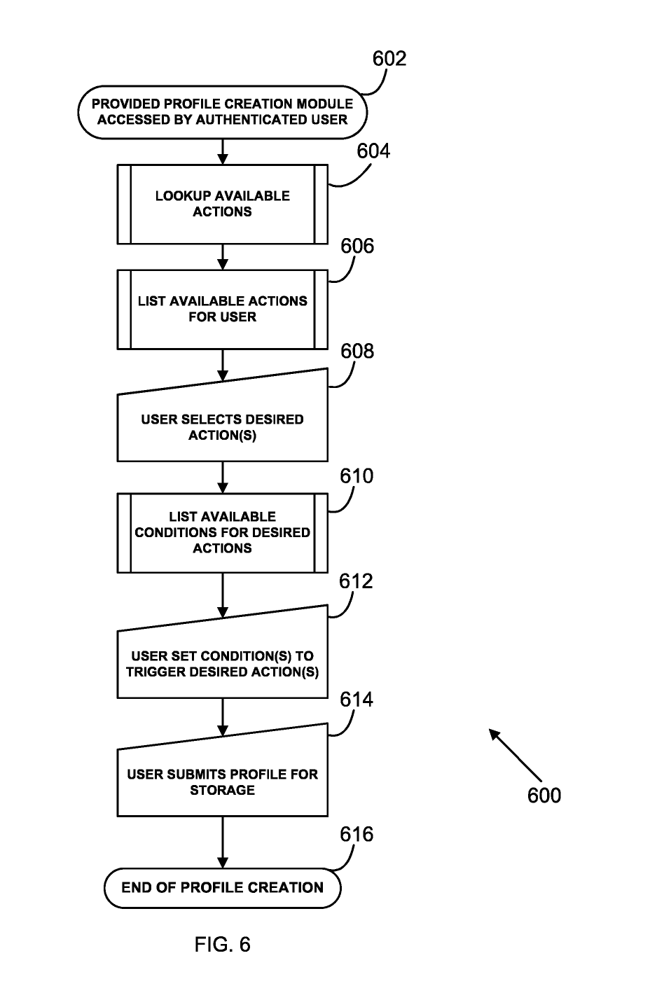

FIG. 6 is a flowchart diagram of an exemplary profile creation module 600. The profile creation module 600 enables the advertiser 106 to access and manipulate the profile. An initial Step 602 comprises the profile creation module being accessed by the advertiser 106. A Step 604 comprises looking up available actions to perform on the profile. A Step 606 may include listing available actions for the advertiser 106. A Step 608 comprises the advertiser 106 selecting an action form the list. A Step 610 involves listing the conditions for the selected action. A Step 612 comprises the advertiser 106 setting conditions to trigger the selected action. In some embodiments, a Step 614 may include, the advertiser 106 submitting a profile for storage in a database. The profile may later be accessed as needed. A final Step 616 terminates the profile creation module 600.

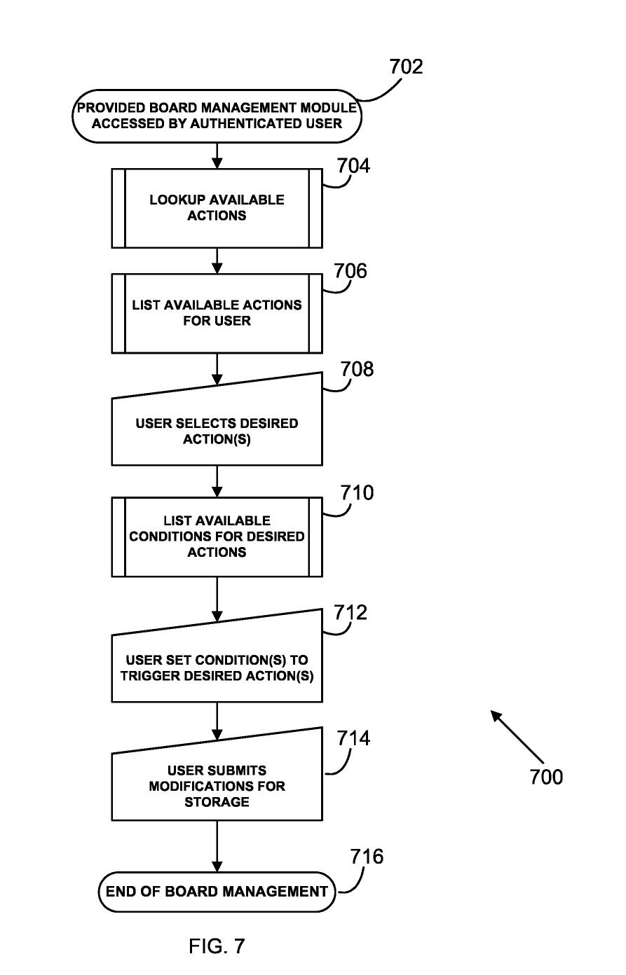

FIG. 7 is a flowchart diagram of an exemplary billboard management module 700. The billboard management module 700 enables the advertiser 106 to access and manipulate a billboard managed profile. In this manner, the advertiser 1106 can be matched with an appropriate billboard 102. An initial Step 702 comprises the billboard management module 700 being accessed by the advertiser 106. A Step 704 comprises looking up available actions to perform on the billboard management module 700. A Step 706 may include listing available actions for the advertiser 1106. A Step 708 comprises the advertiser 106 selecting an action form the list. A Step 710 involves listing the conditions for the selected action. A Step 712 comprises the advertiser 106 setting conditions to trigger the selected action. In some embodiments, a Step 714 may include, the advertiser 106 submitting the billboard management module 700 for storage in a database. The profile from the billboard management module 700 may later be accessed as needed. A final Step 716 terminates the billboard management module 700.

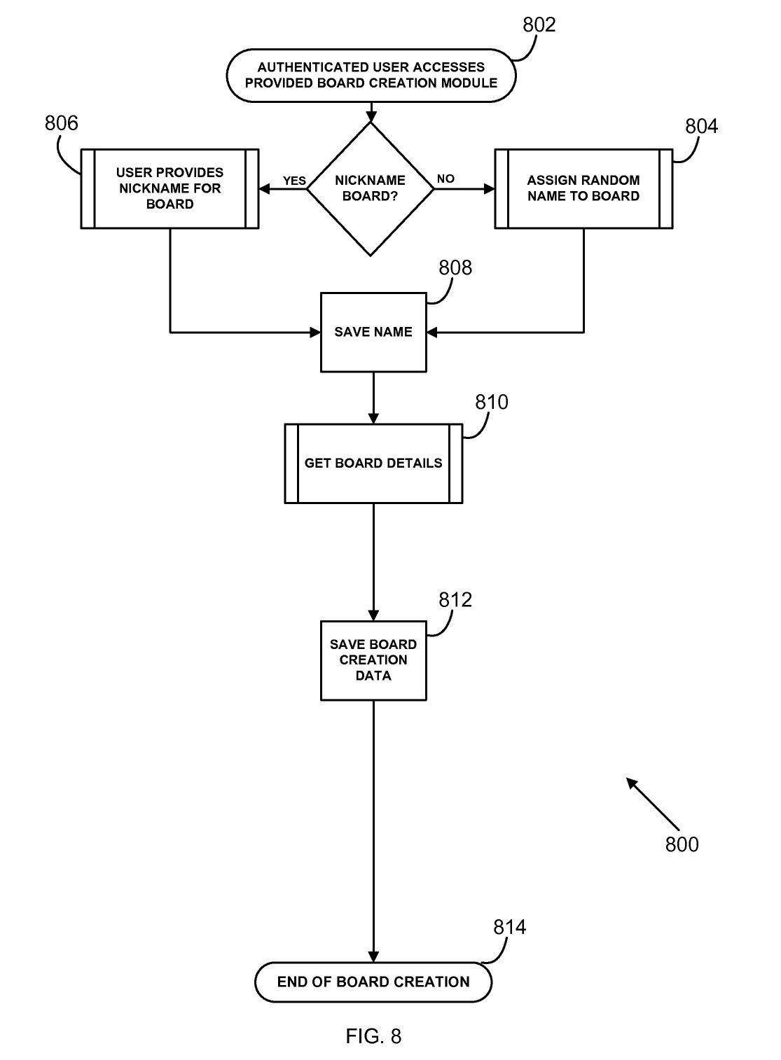

FIG. 8 is a flowchart diagram of an exemplary billboard creation module 800. The billboard creation module 800 enables the advertiser 106 to create a billboard 102. An initial Step 802 comprises an authenticated advertiser 106 accessing a provided billboard creation module 800. If the billboard 102 is not a nickname billboard, a Step 804 may include assigning a random name to the billboard 102, and a Step 808 involves saving the random name. If the billboard 102 is a nickname billboard, a Step 806 may include assigning a nickname to the billboard 102, and a Step 808 involves saving the nickname. In some embodiments, a Step 810 may include obtaining the billboard details, such as company name, registration information, and the like. A Step 812 comprises saving the billboard creation data. A final Step 814 includes ending the billboard creation module 800.

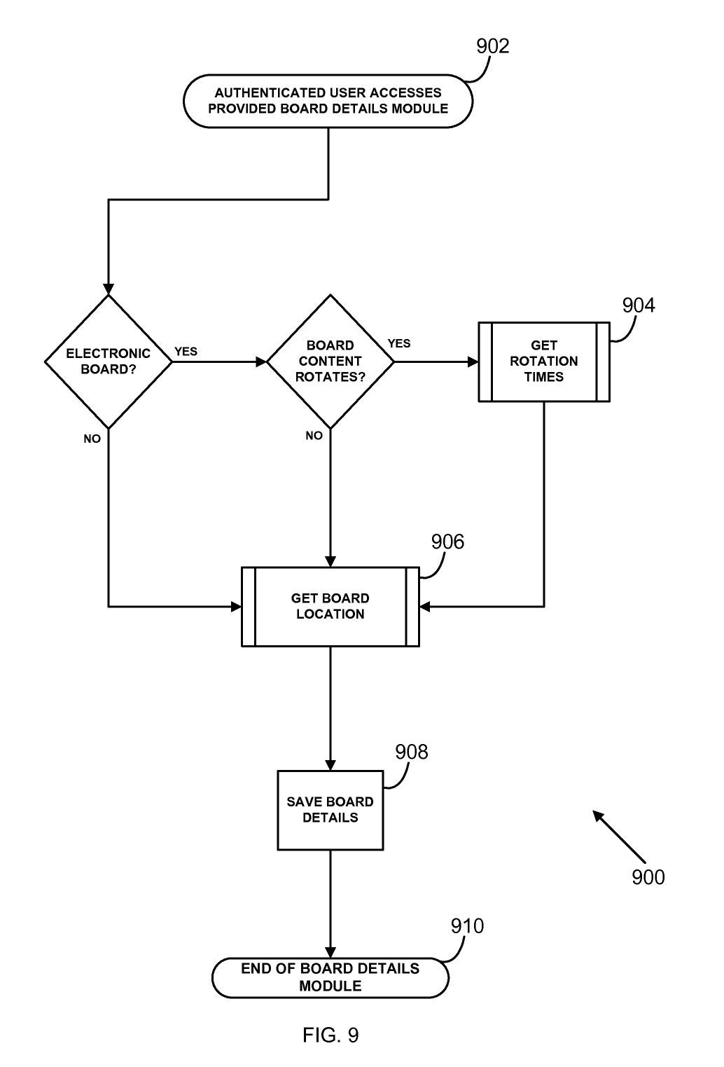

FIG. 9 is a flowchart diagram of an exemplary billboard details module 900. The billboard details module 900 forms the details of the billboard 102, such as the advertisement, the duration of the advertisement, and the display characteristics of the advertisement. A Step 902 includes the authenticated advertiser 106 accessing the billboard details module 900. If the billboard details module 900 is an electronic billboard, the determination must be made whether the billboard content rotates. If the billboard content rotates, a Step 904 comprises obtaining the rotation times. After the rotation times are known, a Step 906 includes obtaining the billboard location. However, if the billboard content does not rotate, the billboard location is determined without requiring Step 904. Further, if the billboard 102 is not electronic, the billboard location is determined without requiring Step 904. In some embodiments, a Step 906 includes saving the billboard details, and a final Step 908 comprises ending the billboard details module 900.

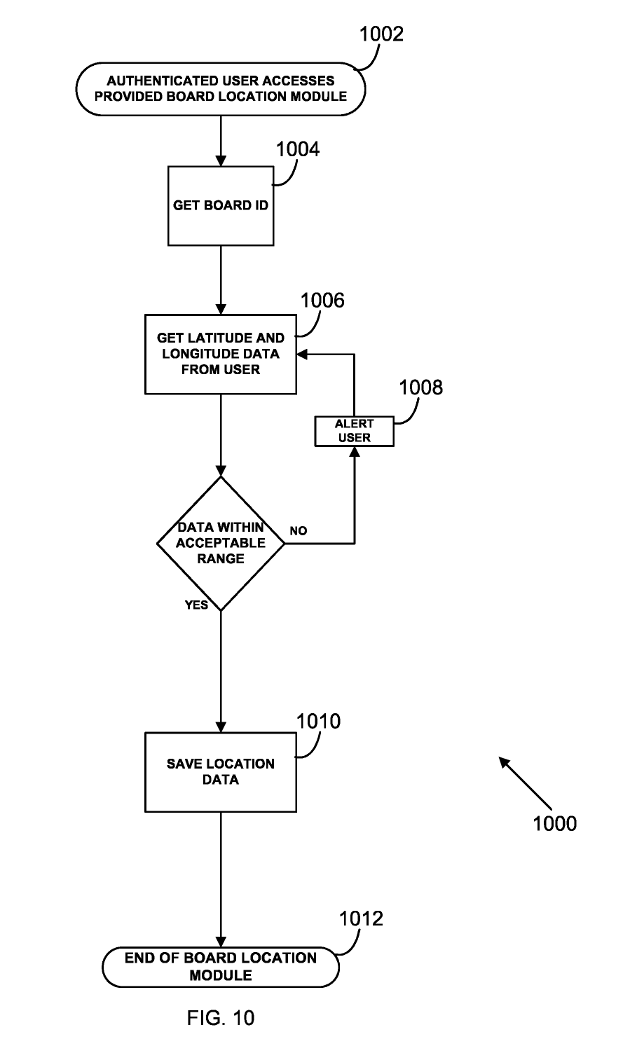

FIG. 10 is a flowchart diagram of an exemplary billboard location module 1000. The billboard location module 1000 utilizes the positioning system 108 to determine the location of the billboard 102. An initial Step 1002 may include the authenticated advertiser 106 accessing the billboard location module 1000. A Step 1004 includes obtaining an identification code for the billboard 102. The identification code is associated with the billboard 102, and enables the positioning system 108 to communicate with the billboard 102. A Step 1006 obtaining the latitude and longitude data 110 from the advertiser 106. If the latitude and longitude data 110 is not within a predetermined acceptable range, a Step 1008 alerts the advertiser 106. The latitude and longitude data 110 may then be obtained repetitively as in Step 1006 until the latitude and longitude data 110 is within an acceptable range. A Step 1010 may then involve saving the latitude and longitude data 110. As described above, the advertiser 106 or the consumer 104 may identify the location of the billboard 102. A final Step 1012 comprises ending the billboard location module 1000.

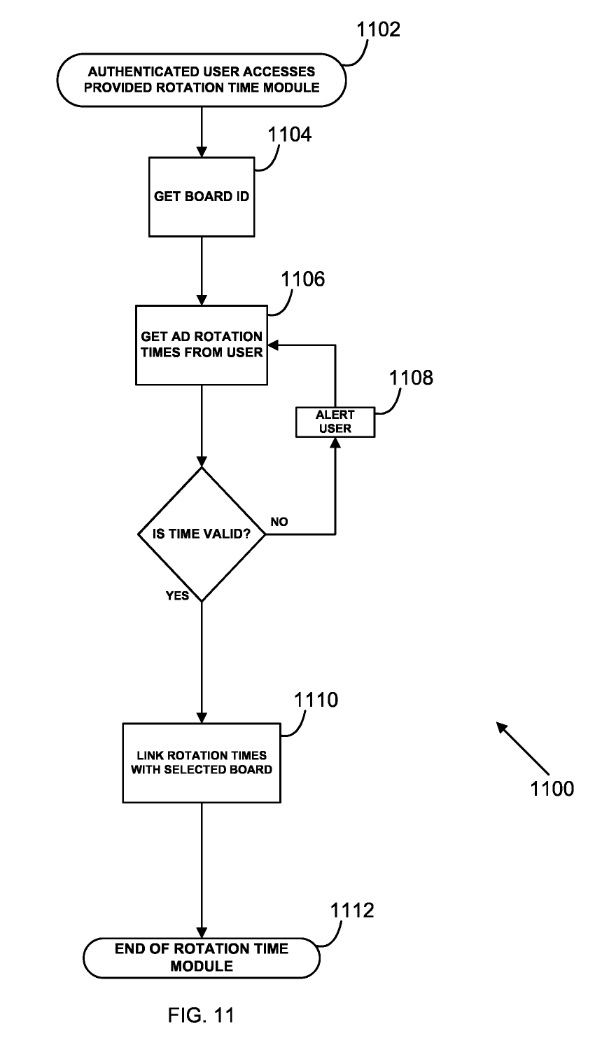

FIG. 11 is a flowchart diagram of an exemplary rotation time module 1100. The rotation time module 1100 is useful for regulating the rotation of advertisements on the billboard 102. This is used generally for electronic billboards. An initial Step 1102 may include the authenticated advertiser 106 accessing the rotation time module 1100. A Step 1104 obtaining an identification code for the billboard 102. The identification code is associated with the billboard 102, and enables the positioning system 108 to communicate with the billboard 102. A Step 1106 may include obtaining an advertisement rotation time for the advertiser 106. If the rotation time is not within a predetermined acceptable range, a Step 1108 alerts the advertiser 106. The rotation time may then be obtained repetitively as in Step 1106 until the rotation time is within an acceptable range. A Step 1110 may then link the rotation time with the associated billboard 102. A Step 1112 comprises ending the rotation time module 1100.

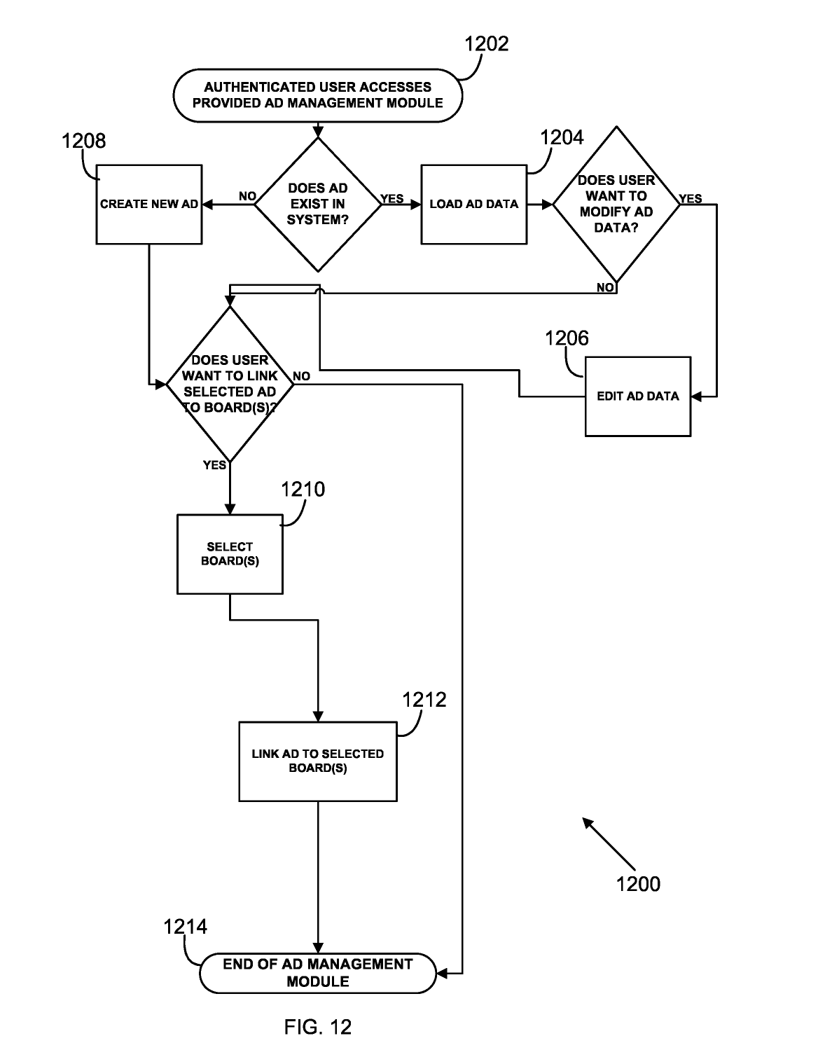

FIG. 12 is a flowchart diagram of an exemplary advertisement management module 1200. The advertisement management module 1200 helps the advertiser 106 regulate and organize the advertisements on the billboard 102. With the advertisement management module 1200, the system 100 may also be more effective in helping the advertiser 106 market the advertisement more effectively. An initial Step 1202 may include the authenticated advertiser 106 accessing the advertisement management module 1200. If the advertisement exists in the system 100, a Step 1204 includes loading the advertisement data into the system 100. If the advertiser 106 does not wish to modify the advertisement, it must be determined if the advertiser 106 wants to link the advertisement to a billboard 102. If the advertiser 106 wishes to link the advertisement to the billboard 102, a Step 1210 comprises selecting the billboard 102. However, if the advertiser 106 does not wish to link the advertisement with the billboard 102, then a terminal Step 1214 ends the advertisement management module 1200. Further, if the advertisement does not exist in the system 100, a Step 1208 involves creating a new advertisement. The advertiser 106 may utilize various means to select an appropriate advertisement for the billboard 102. After creating the new advertisement, the advertiser 106 may then move to the previously mentioned Step 1210 or Step 1214, depending on whether the advertiser 106 wishes to link the advertisement to the billboard 102.

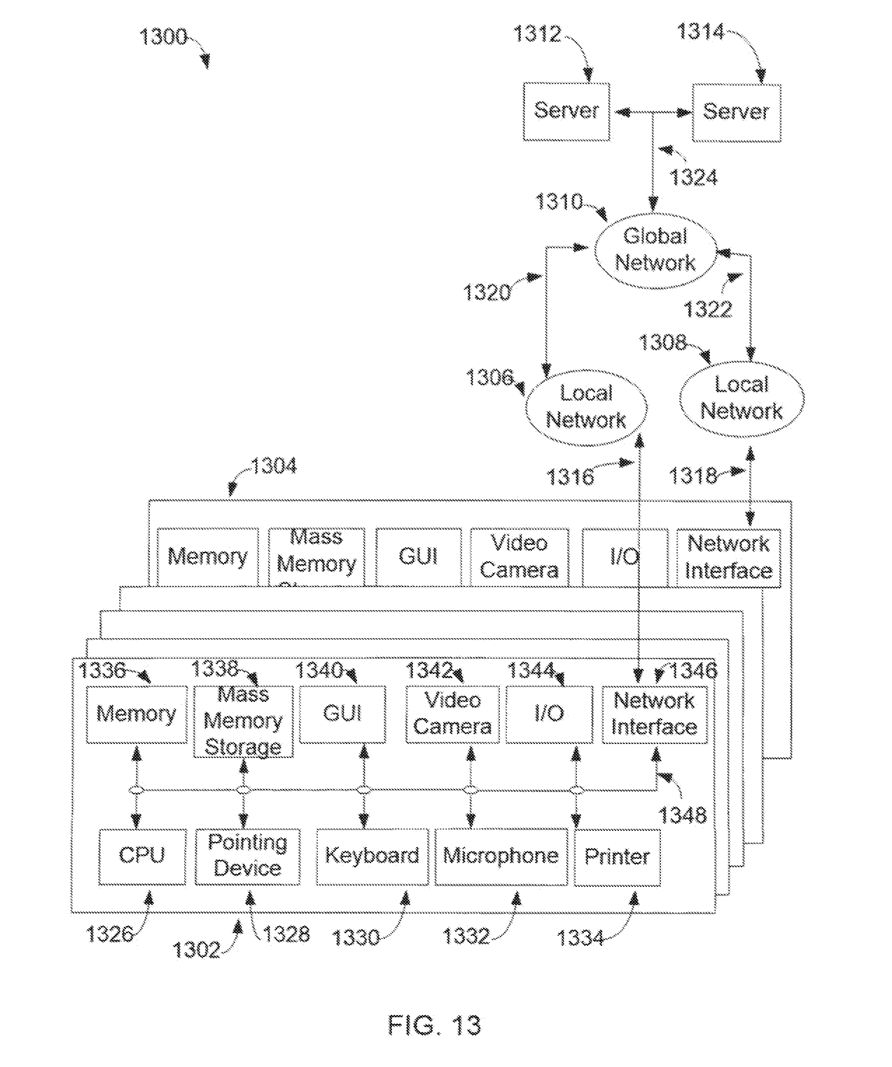

FIG. 13 is a block diagram depicting an exemplary client/server system which may be used by an exemplary web-enabled/networked embodiment of the present invention.

A communication system 1300 includes a multiplicity of clients with a sampling of clients denoted as a client 1302 and a client 1304, a multiplicity of local networks with a sampling of networks denoted as a local network 1306 and a local network 1308, a global network 1310 and a multiplicity of servers with a sampling of servers denoted as a server 1312 and a server 1314.

Client 1302 may communicate bi-directionally with local network 1306 via a communication channel 1316. Client 1304 may communicate bi-directionally with local network 1308 via a communication channel 1318. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones.

Client 1302 includes a CPU 1326, a pointing device 1328, a keyboard 1330, a microphone 1332, a printer 1334, a memory 1336, a mass memory storage 1338, a GUI 1340, a video camera 1342, an input/output interface 1344 and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326 and provides additional data storage capacity and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software. CPU 1326 may be coupled to pointing device 1328. Non-limiting examples of pointing device 1328 include computer mouse, trackball and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof Many other variations are possible. For example, the billboard could be made mobile with wheels, a steering system, and a motor. Accordingly, the scope should be determined not by the embodiments illustrated, but by the appended claims and their legal equivalents.

What is claimed is:

1. A billboard marketing system for enabling a consumer and an advertiser to rate and track a billboard through interactive functions, the billboard marketing system comprising:
a billboard comprising a billboard content, the billboard content configured to display a message from an advertiser, the billboard content further configured to enable a consumer to view the message;
a positioning system configured to identify a position of the billboard and a position of the consumer, the position of the billboard and the position of the consumer comprising a latitude and longitude data;
a data storage unit configured to store the latitude and longitude data;
a computer configured to enable interaction between the consumer and the billboard, the interaction comprising an interaction data;
the data storage unit further configured to store the interaction data;
wherein the latitude and longitude data and the interaction data are configured to help the advertiser enhance marketing.

2. The system of claim 1, in which the consumer comprises a vehicle occupant.

3. The system of claim 1, in which the positioning system comprises a global positioning system.

4. The system of claim 1, in which the system comprises a processing unit configured to query the latitude and longitude data and the interaction data from the data storage unit.

5. The system of claim 1, in which the processing unit is configured to perform an algorithm for determining a proximal billboard to the consumer.

6. The system of claim 1, in which the computer comprises a laptop.

7. The system of claim 1, in which the computer comprises a screen configured to display the latitude and longitude data and the interaction data.

8. The system of claim 1, in which the positioning system is configured to identify the position of the consumer while performing an interaction with the billboard.

9. The system of claim 1, in which the interaction data comprising a discount request, and/or a review, and/or a purchase of a product or service represented in the advertisement.

10. The system of claim 1, in which the interaction data relays from the computer to the processing unit to the data storage unit.

11. The system of claim 1, in which the positioning system is configured to track a route followed by the consumer relative to the billboard, the route configured to identify a behavior of the consumer for the advertiser.

12. The system of claim 1, in which the latitude and longitude data comprises a billboard location, and a consumer location.

13. The system of claim 1, in which the interaction data comprises a discount request, a review, and/or a purchase and/or a product or service inquiry, and/or a landing website page URL for an advertiser, and/or an expiration date for a product or service.

14. The system of claim 1, in which the discount request comprises a coupon.

15. The system of claim 1, in which the review comprises a comparative review of the billboard and/or the product and/or service and/or the advertiser, the review configured to display on the Internet on a national and an international platform.

16. The system of claim 1, in which the system is configured to enable the consumer to save a billboard content for viewing at a later time.

17. The system of claim 1, in which the data storage unit comprises a server.

18. The system of claim 1, in which the processing unit comprises a processing computer.

19. One or more computer storage media storing computer-usable instructions, that when used by one or more computing devices, cause the one or more computing devices to perform a method for marketing a billboard, the method comprising the steps of:
(a) viewing, by a consumer, a billboard;
(b) interacting, by the consumer, with the billboard;
(c) identifying, by an advertiser, a location of the billboard and the consumer;
(d) storing the consumer interaction and the billboard location as data; and
(e) retrieving the data for understanding the performance of the billboard and marketing.

20. A non-transitory program storage device readable by a machine tangibly embodying a program of instructions executable by the machine to perform a method for marketing a billboard, the storage device comprising:
a) computer code for viewing, by a consumer, a billboard;
b) computer code for interacting, by the consumer, with the billboard;
c) computer code for identifying, by an advertiser, a location of the billboard and the consumer;
(f) computer code for storing the consumer interaction and the billboard location as data; and
(g) computer code for retrieving the data for understanding the performance of the billboard and marketing.
